(19) United States
(12) Patent Application Publication
(10) Pub. No.: US 2025/0045057 A1
(43) Pub. Date: Feb. 6, 2025

(54) ARCHITECTURE FOR OPTIMIZING A BOOT-UP PROCESS OF AN INTEGRATED CIRCUIT DEVICE INCLUDING MULTIPLE CHIPLETS

(71) Applicant: QUALCOMM Incorporated, San Diego, CA (US)

(72) Inventors: Praveen RAGHURAMAN, Chennai (IN); Dharani Kumar SRINIVASAN, Chennai (IN); R Hari NARAYANAN, Madurai (IN)

(21) Appl. No.: 18/365,774

(22) Filed: Aug. 4, 2023

(51) Int. Cl. G06F 9/4401

(52) U.S. Cl. CPC G06F 9/4401

(57) ABSTRACT

An integrated circuit device includes a plurality of chiplets. A first chiplet is configured to execute a first boot-up sequence to prepare the first chiplet for operation, and output a trigger signal. A second chiplet is configured to execute a second boot-up sequence to prepare the second chiplet for operation, in response to the trigger signal. The first boot-up sequence at least partially overlaps the second boot-up sequence in time. An example of the integrated circuit device is a System-on-Chip (SoC) that can include various subsystems distributed among multiple chiplets or dies. The boot-up sequences of the subsystems are ordered to increase concurrency between the boot-up sequences. Increasing concurrency of the boot-up sequences between chiplets reduce the overall boot-up time of the SoC.

### TECHNICAL FIELD

The present disclosure relates generally to integrated circuit technology and, more particularly to techniques for optimizing a boot-up process of an integrated circuit device including multiple chiplets or dies.

### BACKGROUND

Mobile communication devices typically include a variety of components such as circuit boards, integrated circuit (IC) devices, application-specific integrated circuit (ASIC) devices, and/or System-on-Chip (SoC) devices. Other types of components may include processing circuits, user interface components, storage and other peripheral components that communicate over a serial bus. State-of-the-art mobile devices demand a small form factor, low cost, a tight power budget, and high electrical performance. For example, wearable processing and communication devices require SoCs and other IC devices that offer higher performance with reduced power requirements in smaller form-factors. Mobile package design has evolved to meet these divergent goals for enabling mobile applications that support multimedia enhancements.

Chiplet technology can be used to address some of the performance, power, size, and other design requirements for complex SoCs used in certain mobile or wearable devices. An SoC can be separated into subsystems that may be implemented as individual chiplets (or dies). An SoC can be optimized or customized by assembling a subset of available chiplets. The assembled chiplets may communicate with each other via one or more intra-chip data buses or similar data communication interconnects on a substrate. A mobile device may include multiple SoCs that communicate with each other via similar inter-chip interconnects.

With increased features in the chiplets and inter-dependency between chiplets, the boot-up or startup processes of chiplets have become a complex process that can impact the execution time and performance of an SoC including multiple chiplets. There is an ongoing need to improve the boot process of chiplet-based SoCs.

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

Certain aspects of the disclosure relate to integrated circuit (IC) devices that include multiple chiplets or dies that can be brought up using at least partially concurrent or overlapping boot-up sequences.

In various aspects of the disclosure, an integrated circuit device (ICD) includes a first chiplet configured to execute a first boot-up sequence to prepare the first chiplet for operation, and output a trigger signal. The ICD further includes a second chiplet configured to execute a second boot-up sequence to prepare the second chiplet for operation, in response to the trigger signal. The first boot-up sequence at least partially overlaps the second boot-up sequence in time.

In various aspects of the disclosure, a method of booting an integrated circuit device (ICD) comprising a plurality of chiplets. The method includes executing a first boot-up sequence of a first chiplet and outputting a trigger signal. The method further includes executing a second boot-up sequence of a second chiplet in response to the trigger signal. The first boot-up sequence at least partially overlaps the second boot-up sequence in time.

In various aspects of the disclosure, an integrated circuit device (ICD) including a plurality of chiplets, includes means for executing a first boot-up sequence of a first chiplet and outputting a trigger signal. The ICD further includes means for executing a second boot-up sequence of a second chiplet in response to the trigger signal. The first boot-up sequence at least partially overlaps the second boot-up sequence in time. In various aspects of the disclosure, a first chiplet included in an integrated circuit device (ICD), includes a plurality of subsystems and one or more processors. The one or more processors are configured to prepare the plurality of subsystems for operation by executing a first boot-up sequence. The first chiplet further includes validation circuitry configured to validate the plurality of subsystems that are prepared by the first boot-up sequence. The one or more processors are configured to trigger a second boot-up sequence configured to prepare a second chiplet included in the ICD for operation, the first boot-up sequence at least partially overlapping the second boot-up sequence in time.

### BRIEF DESCRIPTION OF THE DRAWINGS

FIG. 1 illustrates an apparatus employing interconnected chiplets according to some aspects of the disclosure.

FIG. 2 illustrates certain aspects of a system-on-chip (SoC) constructed from multiple chiplets according to some aspects of the disclosure.

FIG. 3 illustrates an exemplary SoC in which multiple chiplets are stacked vertically on a substrate according to some aspects of the disclosure.

FIG. 4 illustrates exemplary chiplet boot-up sequences of an SoC according to some aspects of the disclosure.

FIG. 5 illustrates exemplary chiplet boot-up sequences that are partially overlapping according to some aspects of the disclosure.

FIG. 6 illustrates additional exemplary chiplet boot-up sequences and validation according to some aspects of the disclosure.

FIG. 7 illustrates an exemplary SoC configured for performing a plurality of chiplet boot-up sequences concurrently according to some aspects of the disclosure.

FIG. 8 illustrates an exemplary chiplet boot-up controller according to some aspects of the disclosure.

FIGS. 9 and 10 illustrate a boot-up process of an SoC using at least partially concurrent chiplet boot-up sequences with validation according to some aspects of the disclosure.

FIG. 11 is flowchart of a method for booting up an SoC with multiple chiplets according to certain aspects of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, firmware, or any combination thereof. Whether such elements are implemented as hardware or software depends upon the particular application and design constraints imposed on the overall system.

Aspects of the disclosure provides various systems, apparatuses, and techniques for optimizing a boot-up process of an integrated circuit device (ICD) including multiple chiplets or dies. An example of such integrated circuit device is a System-on-Chip (SoC) that can include various subsystems distributed among multiple chiplets or dies. A chiplet is a functional unit or die that performs certain specific tasks or provides certain functionality within an SoC. In some examples, the boot-up process of an SoC may also be called a startup process. The boot-up process can vary significantly depending on the specific architecture, design, and purpose of the SoC. In some aspects, the boot-up sequences of the subsystems can be ordered to increase concurrency between the boot-up sequences. Increasing concurrency of the boot-up sequences between chiplets can reduce the overall boot-up time of the SoC. In some aspects, the boot-up process of the SoC can include validation of each chiplet.

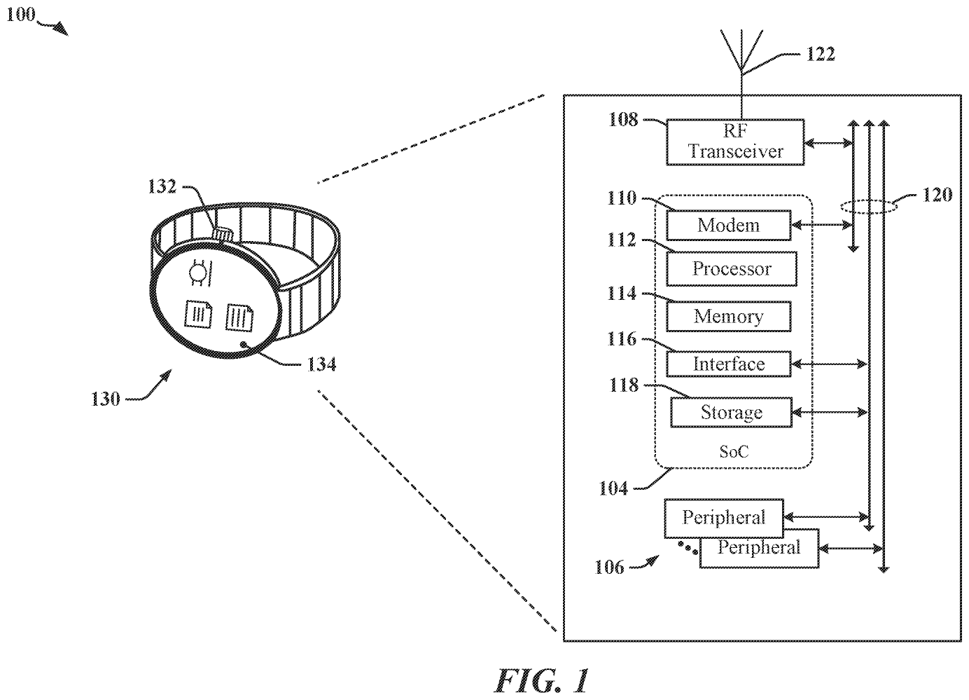

FIG. 1 illustrates an example of an apparatus 100 that may be implemented using multiple chiplets connected through one or more data communication connections (e.g., data buses). In some examples, the apparatus may be enclosed within a portable or wearable device, such as the illustrated smartwatch 130. The apparatus 100 includes multiple circuits or devices 104, 106, and/or 108. In various examples, the multiple circuits or devices can be implemented using one or more ASICs, an SoC, or other devices arranged in a configuration that can be adapted for use in mobile computing, embedded computing, edge computing, etc. In one example, the apparatus 100 may be configured to support multiple communication technologies, modes, or protocols. In some aspects, the apparatus 100 can include a combination of devices including an SoC 104, one or more peripheral devices 106, and a transceiver 108 that cooperate to enable the apparatus to communicate through an antenna 122 with a radio access network, a core access network, another device via a device-to-device connection (e.g., Bluetooth) or a vehicle-to-vehicle connection, the Internet, and/or another network.

In some aspects, the SoC 104 may include various circuitry, for example, one or more processors 112, one or more modems 110, on-board memory 114, a communication interface circuit 116, and/or other logic circuits or functions. The SoC can be controlled by an operating system that provides an application programming interface (API) layer that enables the one or more processors 112 to execute software modules residing in the on-board memory 114 or other processor-readable storage 118 provided on the SoC. The software modules may include instructions and data stored in the on-board memory 114 and/or processor-readable storage 118. The SoC 104 may access its on-board memory 114, the processor-readable storage 118, and/or storage external to the apparatus 100. The on-board memory 114 and the processor-readable storage 118 may include read-only memory (ROM), random-access memory (RAM), electrically erasable programmable ROM (EEPROM), flash memory, or any memory device that can be used in processing systems and computing platforms. The apparatus may include, implement, or have access to a local database or other parameter storage that can maintain operational parameters and other information used to configure and operate the apparatus 100 and/or the SoC 104. The local database may be implemented using registers, a database module, flash memory, magnetic media, EEPROM, soft or hard disk, or the like. The SoC 104 may also be operably coupled to external devices such as the antenna 122, a display 134, operator controls 132, switches or buttons, among other components. A user interface module may be configured to manage the display 134, operator controls 132, etc. and may communicate with other elements of the processing circuit 102, for example, through one or more serial data interconnects.

The apparatus 100 may provide data connections (e.g., buses 120) that enable communication between two or more devices 104, 106, and/or 108. In one example, the SoC 104 may include communication interface circuits 116 coupled to one or more of the buses 120. Each of the communication interface circuits 116 may include a combination of circuits, counters, timers, control logic and other configurable circuits or modules. In one example, certain communication interface circuits 116 may be configured to operate in accordance with standards-defined communication specifications or protocols. The apparatus 100 may include or control a power management function that configures and manages the operation of the apparatus 100.

The illustrated smartwatch 130, other portable or wearable processing and/or communication devices (referred to collectively as portable communication devices or PCDs), sensors, instruments, appliances, and other such devices may include one or more ICs. These devices may include mobile phones, tablet computers, palmtop computers, portable digital assistants (PDAs), portable game consoles, tablets, and other portable electronic devices. PCDs commonly contain integrated circuits or SoCs that include numerous components or subsystems designed to work together to deliver functionality to a user. The various SoC subsystems may communicate with each other via one or more intra-chip data buses or similar data communication interconnects. PCDs may have multiple SoCs that communicate with each other via similar inter-chip interconnects. The ICs are typically packaged in an IC package, which may be referred to as a “semiconductor package” or “chip package.” The IC package typically includes a package substrate and one or more IC chips, dies, chiplets, or other electronic modules mounted to the package substrate to provide electrical connectivity to the IC chips, dies, or chiplets. For example, an IC chip in an IC package may be configured as an SoC. The IC chips are electrically coupled to other IC chips and/or to other components in the IC package through electrical coupling to metal lines in the package substrate. The IC chips can also be electrically coupled to other circuits outside the IC package through electrical connections of external metal interconnects (e.g., solder bumps) of the IC package.

Process technology employed to manufacture semiconductor devices, including IC devices is continually improving. Process technology includes the manufacturing methods used to make IC devices and defines transistor size, operating voltages and switching speeds. Features that are constituent elements of circuits in an IC device may be referred as technology nodes and/or process nodes. The terms technology node, process node, and process technology may be used to characterize a specific semiconductor manufacturing process and corresponding design rules. Faster and more power-efficient technology nodes are being continuously developed through the use of smaller feature size to produce smaller transistors that enable the manufacture of higher-density ICs. Design rules for newer process technology that use low-voltage transistors may preclude the use of higher voltage transistors supported by previous process technology generations. The unavailability of certain higher-voltage transistors may present an impediment to circuit designers for IC devices that include multiple voltage domains.

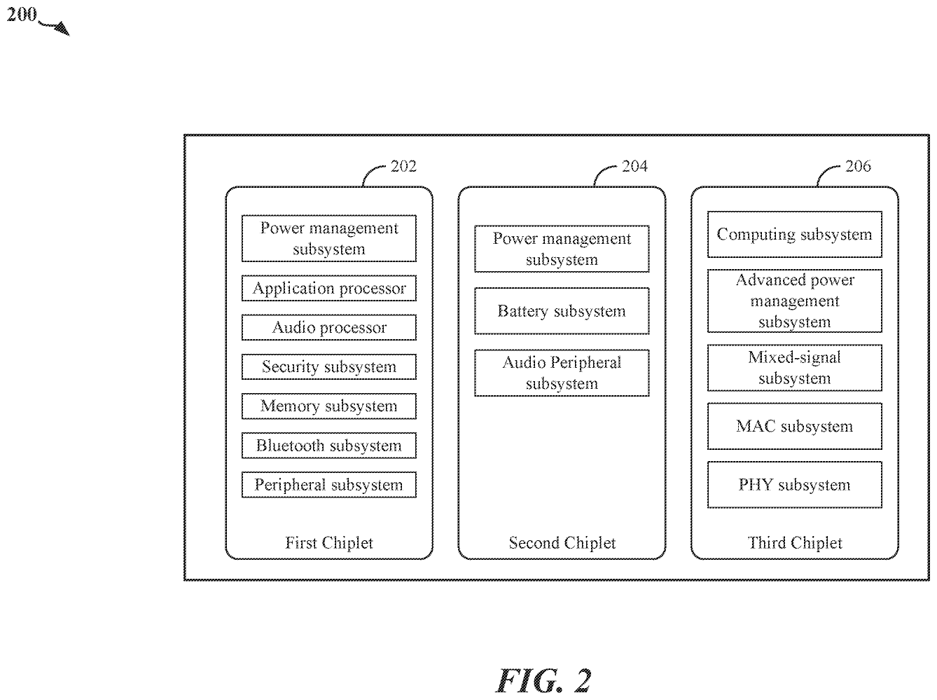

In some aspects, chiplet technology can be used to address some of the performance, power, and size design requirements for complex SoCs used in certain mobile or wearable devices. The block diagram in FIG. 2 illustrates certain aspects of an SoC 200 that can be constructed using chiplets according to some aspects. The SoC 200 may be configured by selecting a combination of chiplets that implement certain subsystems or distinct functional elements. In the illustrated example, the SoC 200 may include multiple chiplets, for example, a first chiplet 202, a second chiplet 204, and a third chiplet 206. In other examples, the SoC 200 may include fewer or more chiplets than those shown in FIG. 2. The chiplets can be used to provide various subsystems or functions of the SoC.

In some aspects, the first chiplet 202 includes a power management subsystem, an application processor, an audio processor, a security subsystem, a memory subsystem, a Bluetooth subsystem, and a peripheral subsystem. In some aspects, the second chiplet 204 includes a power management subsystem, a battery subsystem, and an audio peripheral subsystem. In some aspects, the third chiplet 206 includes a computing subsystem, an advanced power management subsystem, a mixed-signaled subsystem, a media access control (MAC) subsystem, and a physical layer (PHY) subsystem. In other examples, the chiplets may have different configuration of functions and subsystems described above and illustrated in FIG. 2. In some aspects, the SoC may have subsystems different from those illustrated in FIG. 2.

In some aspects, the SoC 200 may include a variety of processing engines, such as central processing units (CPUs) with multiple cores, graphical processing units (GPUs), digital signal processors (DSPs), neural processing units (NPUs), wireless transceiver units (also referred to as modems), peripherals, display and imaging interfaces, etc. Each of these subsystems and other functional elements can be implemented as an individual chiplet, or as a combination of chiplets (e.g., chiplets 202, 204, and 206). The chiplets included in the SoC 200 can be proprietary or may be acquired from a variety of sources. An SoC may be constructed from chiplets manufactured at different process nodes, operated at different voltages, and/or operated at different frequencies.

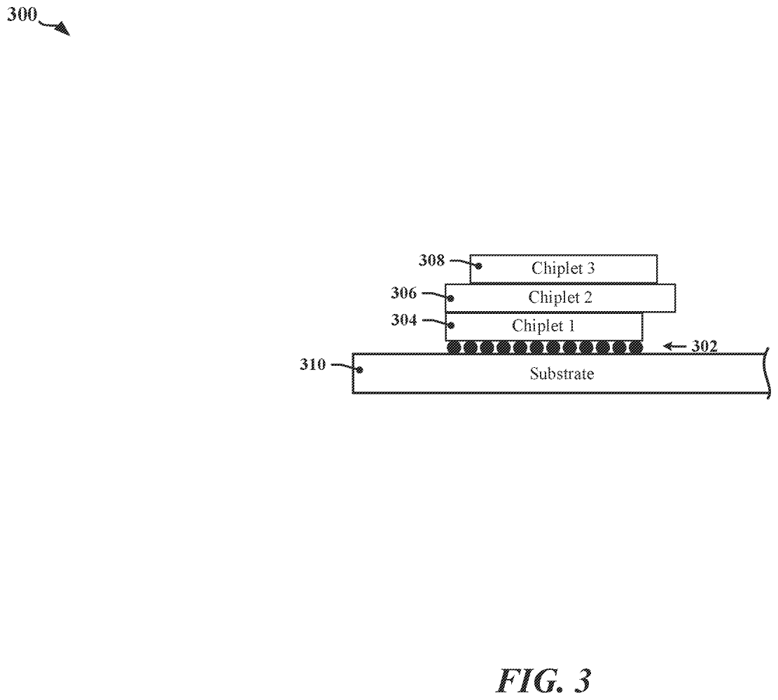

FIG. 3 illustrates an example of an SoC 300 in which exemplary chiplets 304, 306, 308 are stacked on a substrate 310. In other examples, some chiplets can be included in stacks that are deployed across the surface of the substrate 310, while other chiplets may be individually mounted on the surface of the substrate 310. In some aspects, chiplets may be mounted on the surface of the substrate using solder balls 302 (e.g., flip chip/wire-bond/through silicon via (TSV) bumps) that provide electrical and/or thermal coupling between the substrate 310 and the mounted chiplets 304, 306, and 308. An interconnect structure may be formed that enables the chiplets 304, 306, 308 (e.g., in a stack of chiplets) to communicate with one another, with other chiplets mounted on the substrate 310, and with input/output structures that connect the SoC 300 with other circuits, displays, imaging sensors, and other peripherals with an apparatus.

The use of chiplets can reduce the areal size of the substrate 310 and increase three-dimensional packing density. The constituent chiplets may provide complex features and high performance within a smaller form-factor operated at lower power specifications. Moreover, each chiplet may define multiple power domains, operate at different frequencies, and different chiplets may manage power/frequency modes independently. In some instances, two or more chiplets may be operated in mutually exclusive power states. Additionally, operating conditions for an SoC may depend on the type, number, and arrangement of chiplets included on the substrate in addition to the modes of operation defined by applications. It is necessary to consider power usage by all chiplets in the SoC in order to ensure compliance with power budgets assigned for an application or device.

The boot-up process of an SoC (e.g., SoC 200, 300) with multiple chiplets or dies involves a series of steps or processes to initialize and bring up the entire system or SoC. For example, the boot-up process can include power-on, power sequencing, individual chiplet boot-up processes, inter-chiplet communication setup, etc. During power-on, the SoC receives power, either from a battery or an external power source, initiating the boot-up process. In some aspects, the SoC may receive an external boot trigger signal that initiates the boot-up process. With power sequencing, the proper power sequencing is established to ensure that each chiplet receives power in the correct order, preventing potential issues like voltage spikes or excessive power draw during startup. During individual chiplet initialization or boot-up, each chiplet within the SoC goes through its own initialization and boot-up (chiplet boot-up) sequence to bring up its subsystems. For example, the chiplet boot-up process can involve setting up internal registers, configuring clock signals, and preparing the chiplet for operation. During inter-chiplet communication setup, chiplets can establish communication channels with each other to enable inter-chiplet cooperation and data exchange. This can involve configuring the necessary interfaces and protocols for inter-chiplet communication.

In some multi-chiplet configurations, there may be a designated master chiplet or main die responsible for coordinating the boot-up process across all chiplets. The master chiplet or main die can hold additional boot-related functionality, such as containing the boot firmware or controlling the boot sequence. The boot firmware, which can include a bootloader, initialization code, and sometimes an operating system, is loaded onto the appropriate chiplets. This firmware can be stored in non-volatile memory, such as flash memory or read-only memory (ROM) that can be located on the master chiplet or substrate 310. Depending on the design of the SoC, there may be a need for synchronization mechanisms and handshaking between chiplets. This ensures that critical operations (e.g., boot-up sequences) across the chiplets are coordinated and executed in a synchronized or ordered manner. During the boot-up process, each chiplet initializes its respective components and subsystems according to a chiplet boot-up sequence. This can include initializing memory, configuring peripheral devices, and establishing communication interfaces with other chiplets.

In some aspects, the chiplets are verified to ensure proper functioning as a whole system. This can involve checking inter-chiplet communication, verifying system-level functionality, and validating the overall system performance. The boot-up process of an SoC with multiple chiplets can vary significantly depending on the specific architecture, design, and purpose of the system. The above description provides a generalized overview of the boot-up process in such a configuration, but the actual implementation may involve additional complexities and optimizations specific to the SoC and its chiplet arrangement.

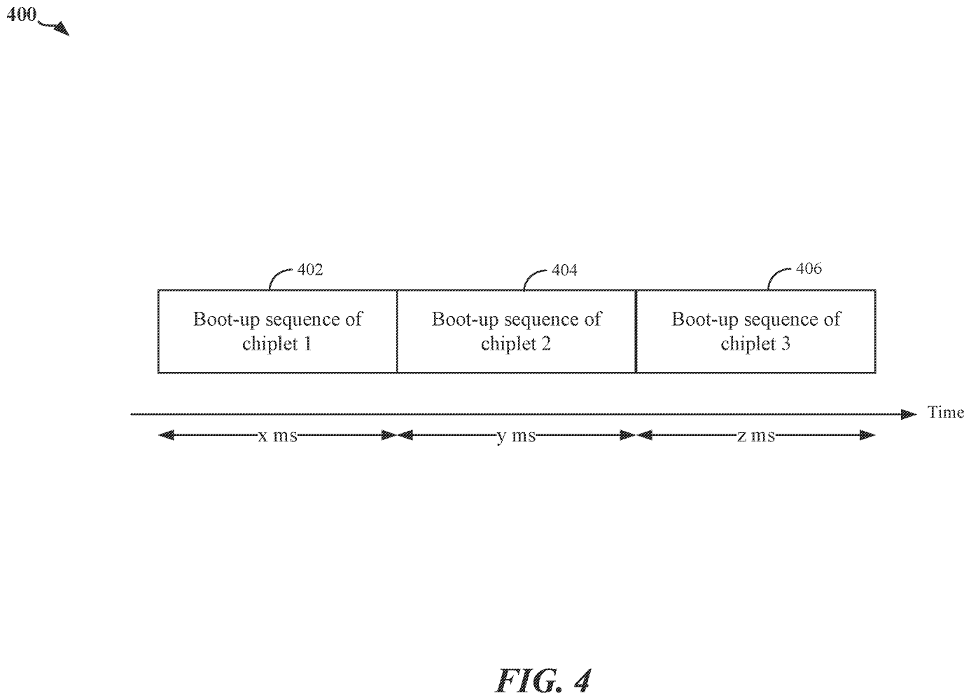

In some aspects, the boot-up sequences of the chiplets are sequential. FIG. 4 is a diagram conceptually illustrating three exemplary chiplet boot-up sequences 402, 404, 406 of an SoC. In each chiplet boot-up sequence, the chiplet brings up its subsystems. The whole boot process is complete once all subsystems are brought-up on all chiplets. In the example shown in FIG. 4, the first chiplet boot-up sequence 402, second chiplet boot-up sequence 404, and third chiplet boot-up sequence 406 are completely sequential in that these boot-up sequences do not overlap in time. In some aspects, the second chiplet boot-up sequence can be triggered or started after the completion of the first chiplet boot-up sequence, and the third chiplet boot-up sequence can be triggered or started after the completion of the second chiplet boot-up sequence.

However, in FIG. 4, the interdependency between the boot-up sequences of chiplets can increase the boot time of the SoC because the chiplet boot-up sequences are sequential. For example, the first, second, and third boot-up sequences can take about x milliseconds (ms), y ms, and z ms, respectively. Therefore, the overall boot-up time of the SoC will be at least x+y+z ms or more. Further, there is no validation of the chiplets during the boot-up processes.

Aspects of the disclosure provide techniques for optimizing a boot-up process of a multi-chiplet SoC by increasing concurrency between the individual boot-up sequences of multiple chiplets included in the SoC. Increasing the concurrency of the boot-up sequences between chiplets can reduce the overall boot-up time of the SoC. In some aspects, the boot-up sequences of the chiplets can include validation of each chiplet to enhance the quality and reliability of the SoC. The techniques can enable low-cost system level testing and improve the quality assurance of the SoC.

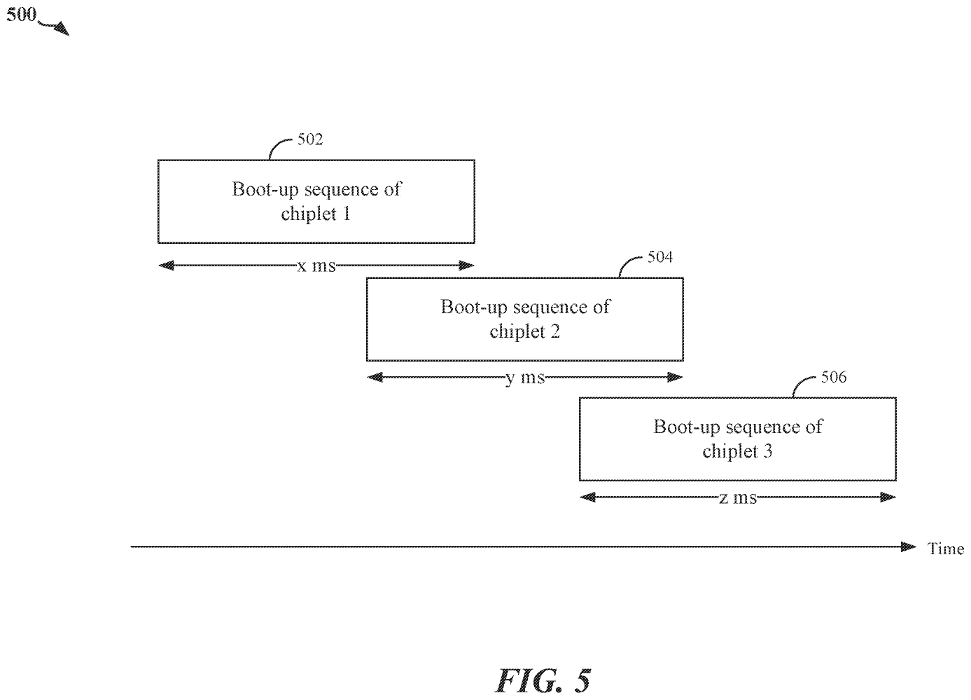

FIG. 5 is a diagram conceptually illustrating three exemplary chiplet boot-up sequences 502, 504, 506 of an SoC that are at least partially overlapping according to some aspects of the disclosure. In each chiplet boot-up sequence, the chiplet (e.g., chiplet 202, 204, 206—indicated in FIG. 2) brings up its processor and/or subsystem(s). In this disclosure, a chiplet is considered booted up and ready when all its processor(s) and/or subsystem(s) are set up and/or initialized. In some aspects, the first chiplet boot-up sequence 502, second chiplet boot-up sequence 504, and third chiplet boot-up sequence 506 can at least partially overlap in time.

In some aspects, the second chiplet boot-up sequence 504 can be triggered or started by the first chiplet boot-up sequence 502 while it is still on-going. In some aspects, the third chiplet boot-up sequence 506 can be triggered or started by the second chiplet boot-up sequence 504 while it is still on-going. To enable the concurrency between the chiplet boot-up sequences, the subsystem initialization processes in one or more of the chiplet boot-up sequences can be ordered to reduce the interdependency between the chiplet boot-up sequences. Reducing the interdependency of the chiplet boot-up sequences enables the concurrency between these sequences to be increased. For example, the first, second, and third boot-up sequences 502, 504, and 506 can consume about x ms, y ms, and z ms, respectively. However, the overall boot-up time of the SoC can be less than x+y+z ms when these chiplet boot-up sequences are performed at least partially concurrently. In some aspects, the degree of concurrency between the chiplet boot-up sequences can be the same or different between different chiplets. For example, the degree of concurrency between the first chiplet boot-up sequence 502 and second chiplet boot-up sequence 504 can the same or different than the degree of concurrency between the second chiplet boot-up sequence 504 and third chiplet boot-up sequence 506. In other examples, the first chiplet boot-up sequence 502 can at least partially overlap with the second chiplet boot-up sequence 504 and/or the third chiplet boot-up sequence 506.

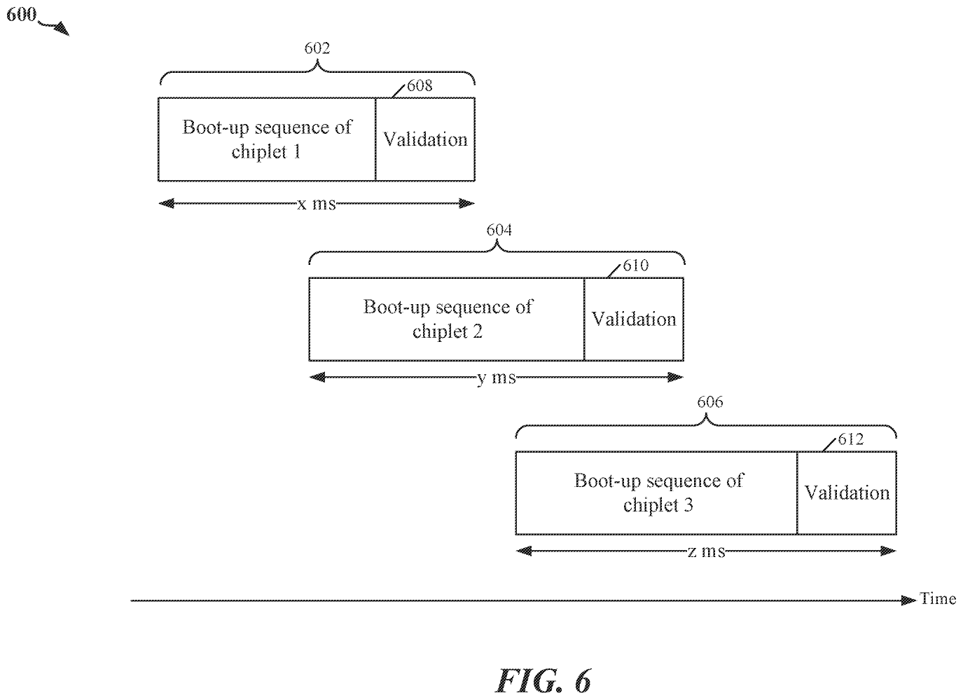

FIG. 6 is a diagram conceptually illustrating three exemplary chiplet boot-up sequences of an SoC according to some aspects of the disclosure. The chiplet boot-up sequences (e.g., first chiplet boot-up sequence 602, second chiplet boot-up sequence 604, and third chiplet boot-up sequence 606) can at least partially overlap in time. For example, the first chiplet boot-up sequence 602 can at least partially overlap with the second chiplet boot-up sequence 604 and/or the third chiplet boot-up sequence 606. Further, different from the chiplet boot-up sequences described above in relation to FIG. 5, the chiplet boot-up sequences 602, 604, 606 each can include validation of the corresponding chiplet. FIG. 6 illustrates that each chiplet boot-up sequence includes validation (e.g., validations 608, 610 and 612). However, in some examples, one or more of the chiplet boot-up sequences of an SoC may not include validation. Further, the validation of the chiplets may be different in function and/or duration. Performing validation in each chiplet can enhance the quality and reliability of the SoC.

In some aspects, validation of a chiplet may include various processes of testing and verifying the functionality, performance, and reliability of the chiplet. In one example, validation may include functional tests to ensure that the chiplet can perform its intended tasks or functions correctly. This may involve running a range of tests, for example, including input/output validation, performance testing, and compliance with industry standards. In one example, validation may include performance evaluation to ensure that the chiplet meets the performance requirements specified for its intended use and can handle the expected workload. In one example, validation may include power and thermal validation to ensure that the chiplet can stay within the specified limits. In one example, validation may include reliability and stress testing that involves running stress tests, accelerated aging tests, and other reliability analysis techniques to identify potential failure modes and ensure the chiplet can withstand the expected operating conditions. In one example, validation may include manufacturing testing that involves running structural tests to identify potential failures at transistor level. Once the chiplets pass the individual validation tests, the entire SoC can undergo system-level integration and validation. This may involve testing the interaction between the chiplets and other system components, verifying system-level performance, and ensuring overall system functionality.

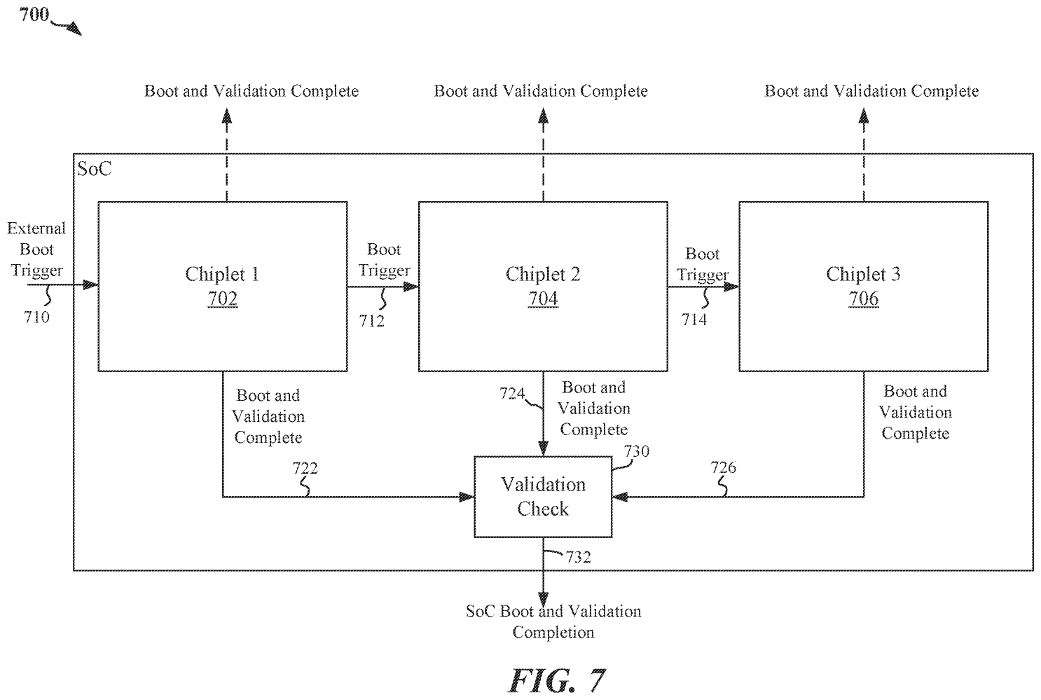

FIG. 7 is a block diagram illustrating an exemplary SoC 700 configured for performing a plurality of chiplet boot-up sequences at least partially concurrently according to some aspects of the disclosure. For example, the SoC 700 may be the SoC 200 of FIG. 2 or any SoC. The SoC 700 can have multiple chiplets (e.g., three exemplary chiplets 702, 704, 706 are shown in FIG. 7). In some aspects, the first chiplet 702 may be a main die of the SoC, and the second chiplet 704 and third chiplet 706 may be companion dies. The main die can provide the primary functionality of the SoC, for example, executing the main computational tasks, such as the CPU (Central Processing Unit) or GPU (Graphics Processing Unit). In some aspects, the main die can include multiple cores, cache memory, memory controllers, and other key components required for the SoC's primary functionality. The companion die can provide the peripheral functionality of the SoC. For example, the companion die can include components such as I/O controllers, memory interfaces, communication interfaces (e.g., wireless and/or wired interfaces), audio/video codecs, and other peripherals. In some aspects, the companion dies can assist the main die by handling peripheral tasks and managing the input/output operations of the SoC, for example, communication with external devices, memory, sensors, and other peripherals connected to the SoC.

An exemplary boot-up process of the SoC 700 will be described with the chiplets 702, 704, 706 shown in FIG. 7 according to some aspects of the disclosure. The first chiplet 702 (main die) can receive a first boot-up trigger signal 710 (e.g., an external boot trigger signal) that initiates a first boot-up sequence of the first chiplet 702. Before the first boot-up sequence of the first chiplet is completed, the first chiplet can send a second boot-up trigger signal 712 to the second chiplet 704. The second boot-up trigger signal 712 initiates a second boot-up sequence of the second chiplet 704. Before the second boot-up sequence of the second chiplet is completed, the second chiplet can send a third boot-up trigger signal 714 to the third chiplet 706. The third boot-up trigger signal 714 initiates a third boot-up sequence of the third chiplet 706. In this case, the first boot-up sequence and second boot-up sequence can at least partially overlap in time, and the second boot-up sequence and third boot-up sequence can at least partially overlap in time. Each chiplet also can perform validation as part of the boot-up sequence.

In some aspects, each chiplet 702, 704, 706 can output a chiplet boot and validation complete signal 722, 724, 726 that indicates the completion of the boot-up sequence and validation of the corresponding chiplet. The SoC 700 may have validation check circuitry 730 that receives the boot and validation completion signals from the chiplets. Based on the chiplet boot and validation completion signals 722, 724, 726, the validation check circuitry 730 can output an SoC boot and validation complete signal 732 that indicates that the SoC has completed the entire boot-up and validation process of the SoC. In some aspects, the SoC can also output the individual chiplet boot and validation completion signals of the chiplets. Having access to the individual chiplet boot and validation completion signals can enable and facilitate troubleshooting and testing of the SoC if needed. For example, the individual chiplet boot and validation completion signals can be monitored by an external testing equipment.

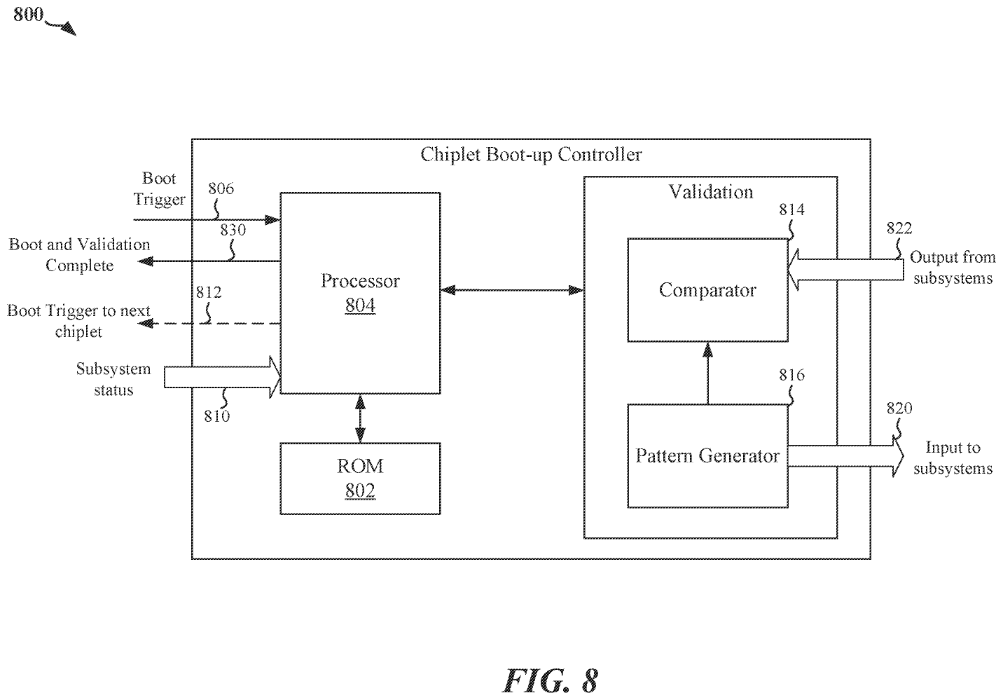

FIG. 8 is a block diagram illustrating an exemplary chiplet boot-up controller 800 according to some aspects of the disclosure. The boot-up controller 800 can be included in each of the chiplets described above in relation to FIGS. 1-7. The boot-up controller 800 can be configured to perform the boot-up sequence and validation of the chiplets described herein.

The controller 800 may include a boot read-only memory (ROM) 802 stored with boot code or instructions for the chiplet. For example, the boot ROM may contain the initial instructions or code that is executed when the chiplet starts its boot-up sequence. The code initializes the chiplet and sets up the necessary configurations to perform the boot process. In some aspects, the controller 800 may include one or more processor (e.g., a processor 804) that can execute the boot code in response to a boot trigger signal 806 (e.g., an external boot trigger signal or a boot trigger signal from another chiplet). In some aspects, the boot ROM of a chiplet may communicate with other components, such as the system memory, to load subsequent boot stages, including the operating system or firmware of the SoC.

The processor 804 can execute the boot code to perform the boot-up sequence of the chiplet. The boot-up sequence can initialize and bring up the subsystems of the chiplets. To that end, the processor 804 can receive subsystem status information 810 from the subsystems. The subsystem status information 810 can indicate whether or not the subsystems have been brought up successfully. Once the subsystems of the chiplet are initialized and brought up, the processor 804 can optionally send a boot trigger signal 812 to the next chiplet if needed.

In some aspects, after the subsystems of the chiplet are brought up, the processor 804 can perform validation of the chiplet including its subsystems. The controller 800 can include validation circuitry for performing various validation functions of the chiplet. For example, the validation circuitry can include a comparator 814 and a pattern generator 816. The pattern generator 816 can generate specific test patterns or stimuli 820 that are applied to the chiplet (e.g., subsystems being tested). The test patterns can include various types of digital and/or analog signals, such as data patterns, clock signals, control signals, and test vectors. The comparator 814 can receive test results 822 output from the subsystems based on the test patterns/stimuli 820. In some aspects, the test patterns can be used to verify the correct behavior and functionality of the subsystems under different scenarios. In some aspects, the test patterns can be used to evaluate parameters such as timing, speed, throughput, power consumption, signal integrity, and other performance metrics. For example, the test patterns can identify potential issues related to timing violations, data corruption, faulty circuitry, and/or other abnormalities that may occur during operation.

Based on the validation result, the processor 804 can output a boot and validation complete signal 830 to indicate that the chiplet has completed the boot-up sequence and validation status (e.g., validation passed or failure). In various examples, the components of the chiplet boot-up controller 800 described above can be implemented using the same or separate circuitry of the chiplets. The SoC can receive the boot and validation complete signal from each chiplet to determine whether or not the SoC has completed the entire boot-up process. Further, the SoC can determine whether or not the chiplets have passed validation.

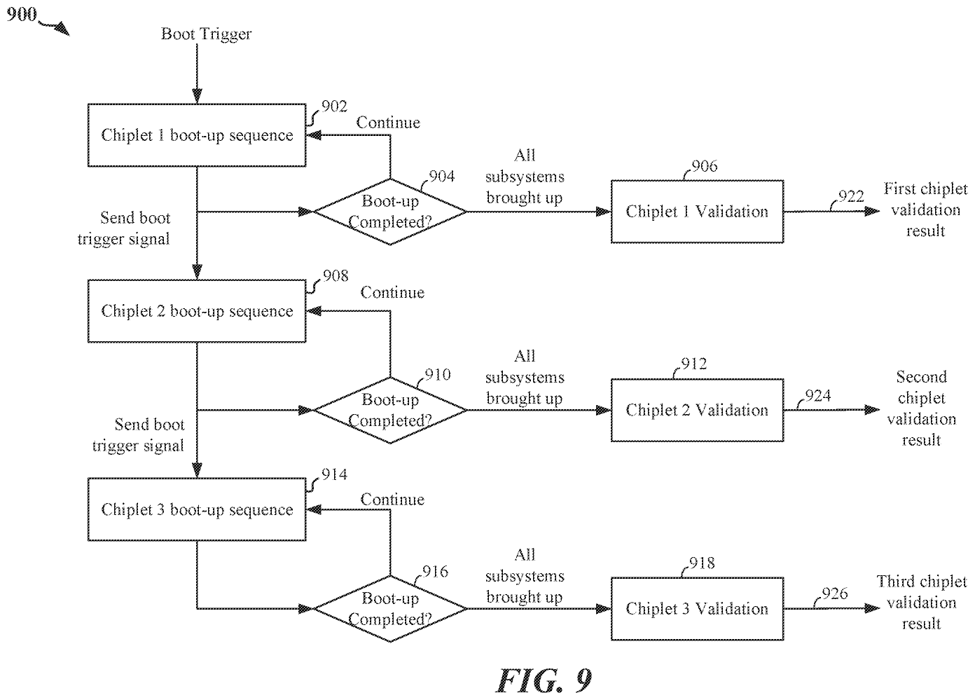

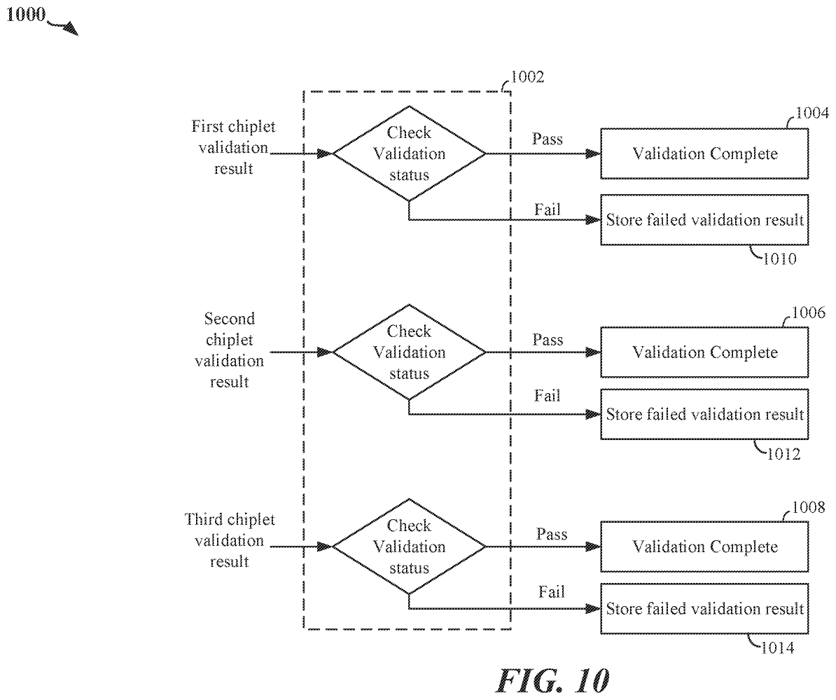

FIGS. 9 and 10 are flow charts illustrating a boot-up process of an SoC using concurrent chiplet boot-up sequences with validation according to some aspects of the disclosure. At 902, a first chiplet performs its boot-up sequence in response to receiving a boot trigger signal. For example, the first chiplet (e.g., chiplet 702 of FIG. 7) may be the master chiplet responsible for coordinating the overall boot-up process across all chiplets of the SoC. The boot trigger signal initiates the first boot-up sequence of the first chiplet. The first boot-up sequence brings up the subsystems of the first chiplet and performs validation of the first chiplet.

At 904, the first chiplet determines whether or not the first boot-up sequence is completed. The first chiplet can continue to bring up its subsystems until all subsystems are brought up. At 906, if the first chiplet determines that all subsystems are brought up, the first chiplet can start validation of the first chiplet. Furthermore, when the first boot-up sequence and/or validation of the first chiplet is ongoing, the first chiplet can send a boot trigger signal to the second chiplet. At 908, in response to the boot trigger signal from the first chiplet, the second chiplet performs a second boot-up sequence.

At 910, the second chiplet determines whether or not to the second boot-up sequence is completed. The second chiplet continues to bring up its subsystems until all subsystems are brought up. At 912, if the second chiplet determines that all subsystems are brought up, the second chiplet can start validation of the second chiplet. Furthermore, when the second boot-up sequence and/or validation of the second chiplet is ongoing, the second chiplet can send a boot trigger signal to third chiplet. At 914, in response to the boot trigger signal from the second chiplet, the third chiplet performs a third boot-up sequence.

At 916, the third chiplet determines whether or not to the third boot-up sequence is completed. The third chiplet continues to bring up its subsystems until all subsystems are brought up. At 918, if the third chiplet determines that all subsystems are brought up, the third chiplet can start validation of the third chiplet.

Each chiplet can output its validation result 922, 924, 926 that indicates whether or not the boot-up and validation of the chiplet is successful. Referring to FIG. 10, at 1002, the SoC can use the validation results from the chiplets (e.g., first validation result 922, second validation result 924, and third validation result 926) to determine if each chiplet has passed or failed validation. At 1004, 1006, 1008, the SoC can determine that the chiplet has completed its boot-up sequence and passed validation. Otherwise, at 1010, 1012, 1014, the SoC can store the failed validation result, for example, in non-volatile memory (e.g., ROM or Flash memory). The failed validation result can be used later for troubleshooting the failed chiplet(s).

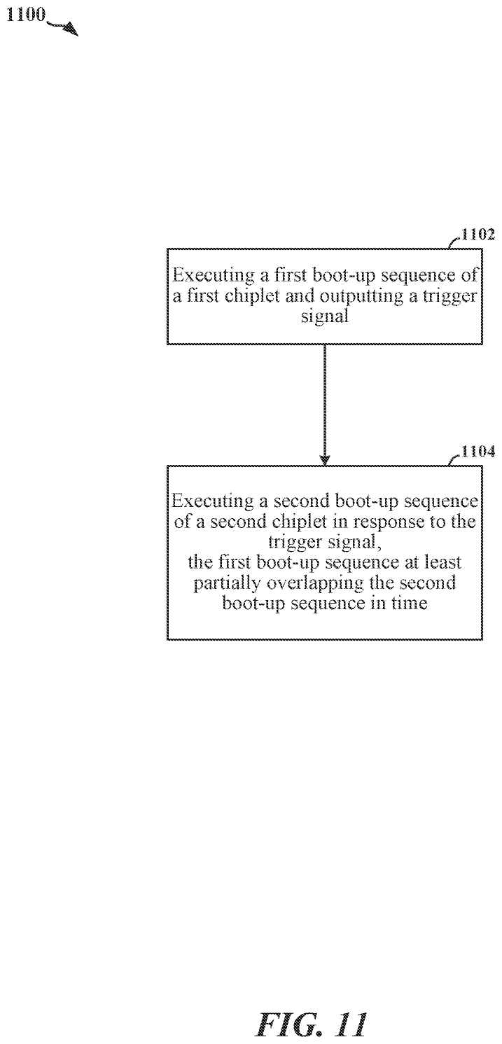

FIG. 11 is a flowchart 1100 of a method for booting up an SoC with multiple chiplets in accordance with certain aspects of this disclosure. In some instances, the method can be implemented using the SoC in a mobile communication device or any devices. In one example, the method can be implemented using the SoC described in relation to FIGS. 1-10.

The SoC can include a plurality of chiplets, for example, a first chiplet and a second chiplet. At block 1102, the method can execute a first boot-up sequence of a first chiplet and output a trigger signal. For example, the first chiplet may be the first chiplet 202 or 702 described above. The first boot-up sequence may be the boot-up sequence 502 or 602 described above. For example, the first chiplet can execute the first boot-up sequence using a processor or controller similar to the chiplet boot controller 800 described above in relation to FIG. 8. For example, the trigger signal may be the boot trigger signal 812 of FIG. 8.

At block 1104, the method can execute a second boot-up sequence of a second chiplet in response to the trigger signal. For example, the second chiplet may be the second chiplet 204 or 704 described above. The first boot-up sequence is configured to trigger the second boot-up sequence. The first boot-up sequence is at least partially overlapping the second boot-up sequence in time. The second boot-up sequence may be the boot-up sequence 504 or 604 described above. For example, the second chiplet can execute the second boot-up sequence using one or processors or a controller similar to the chiplet boot controller 800 described above in relation to FIG. 8.

Some aspects of disclosure provide an integrated circuit device including multiple chiplets that can execute respective boot-up sequences that are at least partially overlapping in time. The device includes means for executing a first boot-up sequence of a first chiplet and outputting a trigger signal. For example, the chiplet boot controller 800 implemented in a first chiplet 702 can provide a means to execute the first boot-up sequence and output a trigger signal. The device can further includes means for executing a second boot-up sequence of a second chiplet in response to the trigger signal. For example, the chiplet boot controller 800 implemented in a second chiplet 704 can provide a means to execute the second boot-up sequence. The first boot-up sequence is configured to trigger the second boot-up sequence, and the first boot-up sequence is at least partially overlapping the second boot-up sequence in time.

In one aspect, the SoC can send, from the first chiplet to the second chiplet, the trigger signal to initiate the second boot-up sequence before the first boot-up sequence completes. In one aspect, the SoC can bring up a plurality of first subsystems of the first chiplet, by the first boot-up sequence; and bring up a plurality of second subsystems of the second chiplet, by the second boot-up sequence. At least a portion of the plurality of first subsystems and at least a portion of the plurality of second subsystems can be brought up concurrently in time.

In one aspect, the SoC can perform a first validation test of the first chiplet and perform a second validation test of the second chiplet. The first validation test at least partially overlaps the second boot-up sequence or the second validation test in time. In one aspect, the SoC can boot up a third chiplet coupled to the second chiplet, using a third boot-up sequence to prepare the third chiplet for operation. The second boot-up sequence of the second chiplet is configured to trigger the third boot-up sequence, and the second boot-up sequence at least partially overlaps the third boot-up sequence in time.

In one aspect, the second validation test of the second chiplet at least partially overlaps the third boot-up sequence in time. In one aspect, the first validation test of the first chiplet at least partially overlaps the second boot-up sequence or the third boot-up sequence in time.

In one aspect, the SoC can perform a third validation test of the third chiplet, output a first validation status signal from the first chiplet based on the first validation test, output a second validation status signal from the second chiplet based on the second validation test, output a third validation status signal from the third chiplet based on the third validation test, and output a boot complete signal of the ICD based on the first validation status signal, the second validation status signal, and the third validation status signal.

The present disclosure may include additional aspects, such as any single aspect or any combination of aspects described below and/or in connection with one or more other processes described elsewhere herein. The following provides an overview of several aspects of the present disclosure.

Aspect 1: an integrated circuit device comprising: a first chiplet configured to execute a first boot-up sequence to prepare the first chiplet for operation, and output a trigger signal; and a second chiplet configured to execute a second boot-up sequence to prepare the second chiplet for operation, in response to the trigger signal, the first boot-up sequence at least partially overlapping the second boot-up sequence in time.

Aspect 2: The integrated circuit device of aspect 1, wherein the trigger signal initiates the second boot-up sequence before the first boot-up sequence completes.

Aspect 3: The integrated circuit device of aspect 1 or 2, wherein: the first chiplet comprises a plurality of first subsystems brought up by the first boot-up sequence; and the second chiplet comprises a plurality of second subsystems brought up by the second boot-up sequence, at least a portion of the plurality of first subsystems and at least a portion of the plurality of second subsystems being brought up concurrently in time.

Aspect 4: The integrated circuit device of aspect 1, wherein: the first chiplet comprises a first controller configured to perform a first validation test of the first chiplet; and the second chiplet comprises a second controller configured to perform a second validation test of the second chiplet, the first validation test at least partially overlapping the second boot-up sequence or the second validation test in time.

Aspect 5: The integrated circuit device of aspect 1 or 4, further comprising: a third chiplet coupled to the second chiplet and configured to execute a third boot-up sequence to prepare the third chiplet for operation, the second boot-up sequence of the second chiplet configured to trigger the third boot-up sequence, and the second boot-up sequence at least partially overlapping the third boot-up sequence in time.

Aspect 6: The integrated circuit device of aspect 5, wherein the second validation test of the second chiplet at least partially overlaps the third boot-up sequence in time.

Aspect 7: The integrated circuit device of aspect 5, wherein the first validation test of the first chiplet at least partially overlaps the second boot-up sequence and the third boot-up sequence in time.

Aspect 8: The integrated circuit device of aspect 5, wherein the third chiplet comprises a third controller configured to perform a third validation test of the third chiplet, the first controller being configured to output a first validation status signal, the second controller being configured to output a second validation status signal, the third controller being configured to output a third validation status signal; and the integrated circuit device further comprising validation circuitry configured to output a boot complete signal based on the first validation status signal, the second validation status signal, and the third validation status signal.

Aspect 9: A method of booting an integrated circuit device (ICD) comprising a plurality of chiplets, comprising: executing a first boot-up sequence of a first chiplet and outputting a trigger signal; and executing a second boot-up sequence of a second chiplet in response to the trigger signal, the first boot-up sequence at least partially overlapping the second boot-up sequence in time.

Aspect 10: The method of aspect 9, further comprising: sending, from the first chiplet to the second chiplet, the trigger signal to initiate the second boot-up sequence before the first boot-up sequence completes.

Aspect 11: The method of aspect 9 or 10, further comprising: bringing up a plurality of first subsystems of the first chiplet, by the first boot-up sequence; and bringing up a plurality of second subsystems of the second chiplet, by the second boot-up sequence, at least a portion of the plurality of first subsystems and at least a portion of the plurality of second subsystems being brought up concurrently in time.

Aspect 12: The method of aspect 9, further comprising: performing a first validation test of the first chiplet; and performing a second validation test of the second chiplet, the first validation test at least partially overlapping the second boot-up sequence or the second validation test in time.

Aspect 13: The method of aspect 9 or 12, further comprising: booting up a third chiplet coupled to the second chiplet, using a third boot-up sequence to prepare the third chiplet for operation, the second boot-up sequence of the second chiplet configured to trigger the third boot-up sequence, and the second boot-up sequence at least partially overlapping the third boot-up sequence in time.

Aspect 14: The method of aspect 13, wherein the second validation test of the second chiplet at least partially overlaps the third boot-up sequence in time.

Aspect 15: The method of aspect 13, wherein the first validation test of the first chiplet at least partially overlaps the second boot-up sequence or the third boot-up sequence in time.

Aspect 16: The method of aspect 13, further comprising: performing a third validation test of the third chiplet; outputting a first validation status signal from the first chiplet based on the first validation test; outputting a second validation status signal from the second chiplet based on the second validation test; outputting a third validation status signal from the third chiplet based on the third validation test; and outputting a boot complete signal of the ICD based on the first validation status signal, the second validation status signal, and the third validation status signal.

Aspect 17: An integrated circuit device comprising a plurality of chiplets, comprising: means for executing a first boot-up sequence of a first chiplet and outputting a trigger signal; and means for executing a second boot-up sequence of a second chiplet in response to the trigger signal, the first boot-up sequence at least partially overlapping the second boot-up sequence in time.

Aspect 18: The integrated circuit device of aspect 17, further comprising: means for sending, from the first chiplet to the second chiplet, the trigger signal to initiate the second boot-up sequence before the first boot-up sequence completes.

Aspect 19: The integrated circuit device of aspect 18 or 17, further comprising: means for bringing up a plurality of first subsystems of the first chiplet, by the first boot-up sequence; and means for bringing up a plurality of second subsystems of the second chiplet, by the second boot-up sequence, at least a portion of the plurality of first subsystems and at least a portion of the plurality of second subsystems being brought up concurrently in time.

Aspect 20: The integrated circuit device of aspect 17, further comprising: means for performing a first validation test of the first chiplet; and means for performing a second validation test of the second chiplet, the first validation test at least partially overlapping the second boot-up sequence or the second validation test in time.

Aspect 21: The integrated circuit device of aspect 17 or 20, further comprising: means for booting up a third chiplet coupled to the second chiplet, using a third boot-up sequence to prepare the third chiplet for operation, the second boot-up sequence of the second chiplet configured to trigger the third boot-up sequence, and the second boot-up sequence at least partially overlapping the third boot-up sequence in time.

Aspect 22. The integrated circuit device of aspect 21, wherein the second validation test of the second chiplet at least partially overlaps the third boot-up sequence in time.

Aspect 23: The integrated circuit device of aspect 21, wherein the first validation test of the first chiplet at least partially overlaps the second boot-up sequence or the third boot-up sequence in time.

Aspect 24: The integrated circuit device of aspect 21, further comprising: means for performing a third validation test of the third chiplet; means for outputting a first validation status signal from the first chiplet based on the first validation test; means for outputting a second validation status signal from the second chiplet based on the second validation test; means for outputting a third validation status signal from the third chiplet based on the third validation test; and means for outputting a boot complete signal of the integrated circuit device based on the first validation status signal, the second validation status signal, and the third validation status signal.

Aspect 25: A first chiplet included in an integrated circuit device (ICD), comprising: a plurality of subsystems; one or more processors configured to prepare the plurality of subsystems for operation by executing a first boot-up sequence; and validation circuitry configured to validate the plurality of subsystems that are prepared by the first boot-up sequence, the one or more processors being configured to trigger a second boot-up sequence configured to prepare a second chiplet included in the ICD for operation, the first boot-up sequence at least partially overlapping the second boot-up sequence in time.

Aspect 26: The first chiplet of aspect 25, wherein the one or more processors are further configured to output a trigger signal that initiates the second boot-up sequence before the first boot-up sequence completes.

Aspect 27: The first chiplet of aspect 25 or 26, wherein the validation circuitry is further configured to: perform a first validation test of the plurality of subsystems, the first validation test at least partially overlapping a second boot-up sequence of the second chiplet in time.

Aspect 28: The first chiplet of aspect 25 or 26, wherein the validation circuitry is further configured to: perform a first validation test of the plurality of subsystems, the first validation test at least partially overlapping a second validation test of the second chiplet in time.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

What is claimed is:

1. An integrated circuit device, comprising:
a first chiplet configured to execute a first boot-up sequence to prepare the first chiplet for operation, and output a trigger signal; and
a second chiplet configured to execute a second boot-up sequence to prepare the second chiplet for operation, in response to the trigger signal,
the first boot-up sequence at least partially overlapping the second boot-up sequence in time.

2. The integrated circuit device of claim 1, wherein the trigger signal initiates the second boot-up sequence before the first boot-up sequence completes.

3. The integrated circuit device of claim 1, wherein:
the first chiplet comprises a plurality of first subsystems brought up by the first boot-up sequence; and
the second chiplet comprises a plurality of second subsystems brought up by the second boot-up sequence,
at least a portion of the plurality of first subsystems and at least a portion of the plurality of second subsystems being brought up concurrently in time.

4. The integrated circuit device of claim 1, wherein:
the first chiplet comprises a first controller configured to perform a first validation test of the first chiplet; and
the second chiplet comprises a second controller configured to perform a second validation test of the second chiplet,
the first validation test at least partially overlapping the second boot-up sequence or the second validation test in time.

5. The integrated circuit device of claim 4, further comprising:
a third chiplet coupled to the second chiplet and configured to execute a third boot-up sequence to prepare the third chiplet for operation,
the second boot-up sequence of the second chiplet configured to trigger the third boot-up sequence, and the second boot-up sequence at least partially overlapping the third boot-up sequence in time.

6. The integrated circuit device of claim 5, wherein the second validation test of the second chiplet at least partially overlaps the third boot-up sequence in time.

7. The integrated circuit device of claim 5, wherein the first validation test of the first chiplet at least partially overlaps the second boot-up sequence and the third boot-up sequence in time.

8. The integrated circuit device of claim 5, wherein the third chiplet comprises a third controller configured to perform a third validation test of the third chiplet,
the first controller being configured to output a first validation status signal,
the second controller being configured to output a second validation status signal,
the third controller being configured to output a third validation status signal; and
the integrated circuit device further comprising validation circuitry configured to output a boot complete signal based on the first validation status signal, the second validation status signal, and the third validation status signal.

9. A method of booting an integrated circuit device (ICD) comprising a plurality of chiplets, comprising:
executing a first boot-up sequence of a first chiplet and outputting a trigger signal; and
executing a second boot-up sequence of a second chiplet in response to the trigger signal,
the first boot-up sequence at least partially overlapping the second boot-up sequence in time.

10. The method of claim 9, further comprising:
sending, from the first chiplet to the second chiplet, the trigger signal to initiate the second boot-up sequence before the first boot-up sequence completes.

11. The method of claim 9, further comprising:
bringing up a plurality of first subsystems of the first chiplet, by the first boot-up sequence; and
bringing up a plurality of second subsystems of the second chiplet, by the second boot-up sequence,
at least a portion of the plurality of first subsystems and at least a portion of the plurality of second subsystems being brought up concurrently in time.

12. The method of claim 9, further comprising:
performing a first validation test of the first chiplet; and
performing a second validation test of the second chiplet,
the first validation test at least partially overlapping the second boot-up sequence or the second validation test in time.

13. The method of claim 12, further comprising:
booting up a third chiplet coupled to the second chiplet, using a third boot-up sequence to prepare the third chiplet for operation,
the second boot-up sequence of the second chiplet configured to trigger the third boot-up sequence, and the second boot-up sequence at least partially overlapping the third boot-up sequence in time.

14. The method of claim 13, wherein the second validation test of the second chiplet at least partially overlaps the third boot-up sequence in time.

15. The method of claim 13, wherein the first validation test of the first chiplet at least partially overlaps the second boot-up sequence or the third boot-up sequence in time.

16. The method of claim 13, further comprising:
performing a third validation test of the third chiplet;
outputting a first validation status signal from the first chiplet based on the first validation test;
outputting a second validation status signal from the second chiplet based on the second validation test;
outputting a third validation status signal from the third chiplet based on the third validation test; and
outputting a boot complete signal of the ICD based on the first validation status signal, the second validation status signal, and the third validation status signal.

17. An integrated circuit device comprising a plurality of chiplets,
comprising:
means for executing a first boot-up sequence of a first chiplet and outputting a trigger signal; and
means for executing a second boot-up sequence of a second chiplet in response to the trigger signal,
the first boot-up sequence at least partially overlapping the second boot-up sequence in time.

18. The integrated circuit device of claim 17, further comprising:
means for sending, from the first chiplet to the second chiplet, the trigger signal to initiate the second boot-up sequence before the first boot-up sequence completes.

19. The integrated circuit device of claim 17, further comprising:
means for bringing up a plurality of first subsystems of the first chiplet, by the first boot-up sequence; and
means for bringing up a plurality of second subsystems of the second chiplet, by the second boot-up sequence,
at least a portion of the plurality of first subsystems and at least a portion of the plurality of second subsystems being brought up concurrently in time.

20. The integrated circuit device of claim 17, further comprising:
means for performing a first validation test of the first chiplet; and
means for performing a second validation test of the second chiplet,
the first validation test at least partially overlapping the second boot-up sequence or the second validation test in time.

21. The integrated circuit device of claim 20, further comprising:
means for booting up a third chiplet coupled to the second chiplet, using a third boot-up sequence to prepare the third chiplet for operation,
the second boot-up sequence of the second chiplet configured to trigger the third boot-up sequence, and the second boot-up sequence at least partially overlapping the third boot-up sequence in time.

22. The integrated circuit device of claim 21, wherein the second validation test of the second chiplet at least partially overlaps the third boot-up sequence in time.

23. The integrated circuit device of claim 21, wherein the first validation test of the first chiplet at least partially overlaps the second boot-up sequence or the third boot-up sequence in time.

24. The integrated circuit device of claim 21, further comprising:
means for performing a third validation test of the third chiplet;
means for outputting a first validation status signal from the first chiplet based on the first validation test;
means for outputting a second validation status signal from the second chiplet based on the second validation test;
means for outputting a third validation status signal from the third chiplet based on the third validation test; and
means for outputting a boot complete signal of the integrated circuit device based on the first validation status signal, the second validation status signal, and the third validation status signal.

25. A first chiplet included in an integrated circuit device (ICD), comprising:
a plurality of subsystems;
one or more processors configured to prepare the plurality of subsystems for operation by executing a first boot-up sequence; and
validation circuitry configured to validate the plurality of subsystems that are prepared by the first boot-up sequence,
the one or more processors being configured to trigger a second boot-up sequence configured to prepare a second chiplet included in the ICD for operation, the first boot-up sequence at least partially overlapping the second boot-up sequence in time.

26. The first chiplet of claim 25, wherein the one or more processors are further configured to output a trigger signal that initiates the second boot-up sequence before the first boot-up sequence completes.

27. The first chiplet of claim 25, wherein the validation circuitry is further configured to:
perform a first validation test of the plurality of subsystems, the first validation test at least partially overlapping a second boot-up sequence of the second chiplet in time.

28. The first chiplet of claim 25, wherein the validation circuitry is further configured to:
perform a first validation test of the plurality of subsystems, the first validation test at least partially overlapping a second validation test of the second chiplet in time.
